(19) United States
(12) Patent Application Publication
(10) Pub. No.: US 2006/0156410 A1
(43) Pub. Date: Jul. 13, 2006

(54) Optimized device for digital data communication in a microcircuit card

(76) Inventors: Herve Gouessant, Vitry Sur Seine (FR); Stephane Jayet, Meyzieu (FR)

Correspondence Address: YOUNG & THOMPSON, 745 SOUTH 23RD STREET, 2ND FLOOR, ARLINGTON, VA, 22202, US

(21) Appl. No.: 10/539,018

(22) PCT Filed: Dec. 17, 2003
(86) PCT No.: PCT/FR03/03773

§ 371 Date: Nov. 30, 2005

(30) Foreign Application Priority Data
Dec. 18, 2002 (FR) 02/16084

(51) Int. Cl. H04N 7/16; H04L 9/32; G06F 17/30; G06F 7/04; G06K 9/00; H03M 1/68; H04K 1/00; H04L 9/00

(52) U.S. Cl. 726/26

(57) ABSTRACT

A microcircuit card includes input/output elements (14) for digital data, elements for processing (12) the data and control elements (26). The processing elements (12) include members for transferring digital data (DMA) between the input/output elements (14) and a storage zone (18), and elements for communicating with the control elements (26), control data obtained at the digital data. The control elements (26) control the transfer of the digital data by the transfer elements (DMA) taking into account the control data.

The present invention relates to a microcircuit card.

To be more precise, the invention is directed to a microcircuit card adapted to:

process a relatively voluminous stream of digital data exchanged with a device external to the card, and

implement security procedures, for example functions for verifying the integrity of the digital data exchanged with the external device or cryptographic functions for authenticating a user of the card.

Thus the invention may be used to decompress an encrypted digital data stream.

In one prior art architecture of this kind of card, the digital data received from an input-output port of the microcircuit card is read by a microprocessor and processed as and when it is received. The microprocessor effects the security checks referred to above as and when it receives digital data.

A major problem with the above architecture is that the digital data stream that can be exchanged by the card is limited by the frequency of the microprocessor (which is generally of the order of 4 MHz in the case of microcircuit cards known in the state of the art).

In other fields of electronics, to alleviate the limits associated with the frequency of a microprocessor, the transfer of data at high bit rates is often effected by means of dedicated direct memory access (DMA) components. These DMA components are programmed by a microprocessor to effect a predetermined transfer, for example between an input-output port and a memory, the microprocessor not handling the transfer as such.

Unfortunately, these DMA components are dedicated to transferring data and are unable to effect processing of data during its transfer. They are therefore not adapted, a priori, for transferring sensitive data necessitating security operations, as is the case for the microcircuit cards cited above.

The invention aims, by overcoming this apparent incompatibility, to enable transfer of a voluminous or fast secure data stream in a microcircuit card whilst maintaining a high security level thanks to an original association of a processor and direct memory access.

To this end, it proposes a microcircuit card including:

input-output means for digital data;

processing means for processing this data; and

stream control means.

The microcircuit card is characterized in that the processing means include:

transfer means for transferring said digital data between the input-output means and a storage area; and

communication means for communicating with the stream control means security data obtained from the digital data, the stream control means being adapted to control the transfer of the digital data by the transfer means taking into account said security data.

Accordingly, the data received from the communication port is transferred by the transfer means to a storage area, the stream of this transfer being not limited by the speed of the stream control means.

Moreover, during this transfer, security data obtained from the digital data is communicated by the processing means to the stream control means, the security data stream received by the stream control means being limited and in any event much less voluminous than the digital data stream received by the card.

The stream control means, consisting, for example, of a processor, are then in a position by using this security data to effect the operations necessary for controlling the transfer means to guarantee compliance with security constraints.

The invention therefore enables the digital data stream processed by the microcircuit card to be more voluminous whilst maintaining the security level of a conventional card.

In a first variant embodiment of the microcircuit card of the invention, the security data referred above consists at least in part of a portion of said digital data transferred by the card.

In a preferred embodiment of this first variant, the security data includes authentication data for authenticating a portion of the digital data received by the card, the stream control means being adapted to verify the validity of said digital data on the basis of this authentication data and to control the transfer as a function of the result of this verification.

In known manner, if the stream control means determine that the authentication data is not valid when the card receives digital data transmitted by an external device, this means that the digital data was not sent by an authorized sender.

In this situation, the stream control means may take a predetermined measure, such as blocking use of the card or sending an error message.

In a preferred embodiment, to guarantee secure use of the card, the stream control means command the transfer means to stop the transfer of digital data if the authentication data is not valid.

Thus the card is able to receive a voluminous data stream, only a portion of that data being communicated to the stream control means to guarantee the required security.

In a second variant embodiment, the processing means are adapted to insert into the security data a result of processing calculated from the digital data.

The processing result may, for example, be the result of a step of verifying the aforementioned authentication data by calculation means included in the processing means, for example cryptographic means of the microcircuit card. This result is then taken account of by the stream control means to verify the integrity of the digital data and to control its transfer by the transfer means accordingly.

This authentication step may consist in verifying a signature, for example using a cryptographic key and a hashing function in accordance with an algorithm of MD4, MD5 or SHA-1 type.

In this variant, the stream control means effect the steps of verifying the authentication data. They may then implement a predetermined measure in the event of fraudulent misuse of the card, such as stopping the transfer of the digital data or blocking the use of the card.

In a preferred embodiment, the stream control means control the transfer of digital data by modifying at least one operating parameter of the transfer means.

For example, this operating parameter is a storage address of the digital data in the storage area.

Accordingly, if the occupancy of a first range of the storage area is above a predetermined threshold, the stream control means can set the parameters of the transfer means so that the digital data received by the transfer means is stored at that address.

The parameter cited above may also be a parameter for selecting the protocol for communication between the input-output means and the storage area. This communication protocol can be, for example, adapted to transferring secure data.

In different variant embodiments of the microcircuit card of the invention, the processing means include a data compression unit, a data decompression unit, a data encryption unit or a data decryption unit.

In another variant embodiment, the stream control means are further adapted to obtain directly from the input-output means preliminary data that is taken account of by the stream control unit to authorize or refuse the transfer of the digital data by the transfer means.

In one particular embodiment of this variant, this preliminary data includes authentication data.

This embodiment provides an additional level of security, for example through checking an authentication code prior to the transfer of the digital data proper. Unlike security data, this authentication code is typically verified once only at the start of a transfer session. It may require a longer calculation time, and therefore employ a complex authentication algorithm providing a higher level of security.

In another preferred embodiment, this preliminary data includes a storage address of the digital data that will be transferred by the transfer means. In this preferred embodiment, this preliminary data may further include data for authenticating the storage address, in order to guarantee that the storage address has not been supplied by an unauthorized user.

In a particularly advantageous embodiment, the microcircuit card further includes regulation means adapted to modify a clock frequency applied to the processing means as a function of said security data.

This feature then allows to limit the electrical power consumption of the microcircuit card if the transfer of digital data by the transfer means must be interrupted.

The invention will be better understood and other advantages of the invention will become more clearly apparent in the light of the following description of a microcircuit card of the invention, which description is given by way of example only and with reference to the appended drawing, in which:

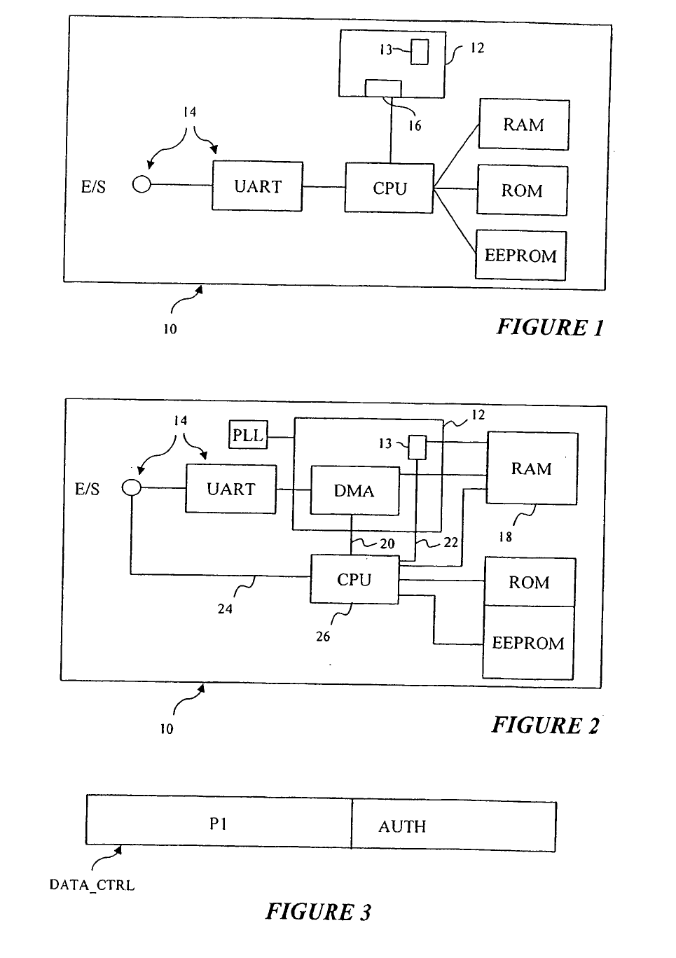

FIG. 1 is a block diagram of a prior art microcircuit card;

FIG. 2 is a block diagram analogous to FIG. 1 showing one possible embodiment of a microcircuit card of the invention; and

FIG. 3 shows an example of security data conforming to the invention.

The prior art microcircuit card 10 shown in FIG. 1 includes primarily a processor CPU associated conventionally with a number of memories (of RAM, ROM, or EEPROM type), processing means 12 and input-output means 14 connected, for example, to a terminal.

The processing means 12 include a calculation unit 13 adapted to perform the actual process of the digital data, that is to say for example operations of compression, decompression, encryption or decryption of these data.

In a preferred embodiment, the input-output means 14 enable the microcircuit card 10 to communicate with an external terminal or electronic entity essentially comprising a UART (universal asynchronous receiver-transmitter).

The input-output means 14 may also be adapted to implement standard communication protocols known to the person skilled in the art, for example the protocols referred to as “T=0”, “T=1” (ISO 7816), USB, FireWire or I2C.

According to the prior art, when microcircuit card 10 receives via the UART digital data that is to be processed by the calculation unit 13 of the processing means 12, the UART sends an interrupt message to the processor CPU. The processor CPU then reads a register of the UART and copies the data therein into the RAM.

The processor CPU then initializes the processing means 12, reads the data to be processed in the RAM and copies it into a register 16 of the processing means 12.

In order to be communicated to the external terminal, the result calculated by the processing means 12 is then read by the processor CPU in the register 16 and copied into the UART register by the processor CPU.

This mode of operation is not favorable to the processing of high bit-rate digital data by the microcircuit card 10. Because the intermediate operation effected by the processor CPU of copying digital data into the RAM area before it is processed by the processing means 12 is particularly penalizing.

However, the requirement is to increase the processing power of this kind of microcircuit card to process voluminous and continuous data streams in real time.

For example, it might be required to be able to carry out real time decryption of digital data representative of sound. Such data is compressed to the MP3 standard and transmitted at a bit rate of 128 kbit/s. The microcircuit card responsible for real time decryption therefore needs to be able to receive and process information at a high bit rate.

A microcircuit card conforming to the invention and solving the above problem is described next with reference to FIG. 2.

In accordance with the present invention, the processing means 12 include means DMA for transferring digital data between the communication port 14 and a storage area 18.

In the FIG. 2 example described here, the storage area 18 is a random access memory RAM.

In other embodiments, the storage area 18 may be selected from various types of rewritable memory, for example Flash memory, EEPROM or hard disk.

In another variant, the storage area 18 is a port of the calculation unit 13 of the processing means 12.

In the preferred embodiment described here, the transfer means DMA include a dedicated electronic direct memory access (DMA) component known to the person skilled in the art.

In known manner, this component is programmed by writing parameters into configuration registers.

By way of non-limiting example, such parameters include the address of a port of the input-output means 14, the address of a range of the storage area 18 in which the digital data must be stored, and parameters representative of a criterion for stopping the transfer.

Be this as it may, the microcircuit card of the invention further includes stream control means 26 adapted to control the transfer of digital data by the transfer means DMA.

In particular, if the digital data must be transferred to a storage area 18 of EEPROM type, the stream control means 26 are adapted to control a voltage generator or any other means of applying a sufficient electrical voltage to the EEPROM for it to be accessible in write mode.

In the embodiment described with reference to FIG. 2, the stream control means 26 consists of a processor CPU conventionally associated with memories (RAM, ROM, EEPROM), as in FIG. 1.

The setting of parameters of the transfer means DMA by the stream control means 26 is represented diagrammatically in FIG. 2 by the signals 20.

In accordance with the present invention, the processing means 12 also include means 22 for communication between its calculation unit 13 and the stream control means 26.

The communication means 22 enable the exchange between the processing means 12 and the stream control means 26 of security data obtained from digital data DATA transferred by the transfer means DMA.

Chronologically, once the transfer means DMA have been programmed by the stream control means 26, by means of the signals 20, the transfer means DMA effect the transfer of the digital data between the input-output means 14 and the storage area 18. The calculation unit 13 of the processing means 12 then obtains security data DATA_CTRL from the digital data DATA stored in the storage area 18 and communicates it to the stream control means 26 via the communication means 22.

FIG. 3 shows one example of the security data DATA_CTRL used in a preferred embodiment.

The security data DATA_CTRL includes a digital data portion P1 and authentication data AUTH calculated from the digital data of the portion P1.

In a first variant, the authentication data AUTH forms a signature of the portion P1. This is typically a data portion P1 to which a prior art hashing function (e.g. an MD4, MD5 or SHA-1 function) and then an encryption algorithm have been applied. A symmetrical key encryption algorithm may be used for this purpose, such as the data encryption standard (DES) algorithm, or an asymmetric key algorithm such as the Rivest, Shamir and Adelman (RSA) algorithm.

In this variant, on receiving this security data DATA_CTRL, the stream control means 26 first decrypt the signature AUTH using the decrypting key and obtain a first result HASH1. The stream control means 26 then apply the hashing function to the portion P1 and obtain a second result HASH2.

The stream control means 26 then compare the first result HASH1 and the second result HASH2.

In a preferred embodiment of this first variant, if these results HASH1 and HASH2 are different, the stream control means 26 send a stop signal to command stopping of the transfer of digital data.

In the preferred embodiment, the processing means 12 insert into the security data DATA_CTRL a result of processing of the digital data DATA by the calculation unit 13.

This processing result is, for example, the address at which a portion of the digital data DATA has been stored in the storage area 18 by the transfer means DMA, the stream control means 26 then being adapted to read the data of that portion, verify its validity, and control the transfer of the digital data DATA by the transfer means DMA as a function of the result of this verification.

In an embodiment in which the processing means 12 include cryptographic means 13, this processing result is the result obtained by the cryptographic unit 13 in a step of authenticating the digital data DATA.

In a variant, the processing result is the result obtained by the cryptographic means 13 in a step of verifying a signature of the digital data DATA.

For example, this verification step may consist in decrypting the data AUTH using an RSA algorithm to obtain a result similar to the first result HASH1.

In a preferred embodiment, the stream control means 26 are further adapted to obtain preliminary data directly from the input-output means 14 over the data path 24 represented in FIG. 2.

In a variant, the preliminary data is obtained by the stream control means 26 from a second input-output port, for example using the protocol referred to as “T=0” (ISO 7816), the input-output means 14 being reserved for the transfer of the digital data DATA by the transfer means DMA.

The data path 24 may also be a bidirectional data path used by the stream control means 26 to communicate information to a device external to the microcircuit card. This information may, for example, consist of an error message sent by the stream control means 26 if they detect the presence of erroneous digital data on the basis of the security information.

This information may also consist of a data stream leaving the microcircuit card that is the result of the processing by the processing means 12 of the digital data DATA received by the card.

This preliminary data includes, for example, authentication data PASSWD and, be this as it may, is taken into account to control the transfer of digital data by the transfer means DMA.

Accordingly, if the authentication data PASSWD does not conform to a predetermined control rule, for example, which rule may be stored in the ROM, the stream control means 26 do not program the transfer means DMA to transfer the digital data between the input-output means 14 and the storage area 18.

The preliminary data preferably includes a digital data storage address.

In a variant, the microcircuit card includes regulation means PLL adapted to modify a clock frequency applied to the processing means 12 as a function of the control data DATA_CTRL.

These regulation means PLL may consist of a phase-locked loop (PLL) component known by the person skilled in the art and used to derive signals at various clock frequencies from a signal from an external clock (not shown).

In the preferred embodiment, these regulation means PLL are controlled by the stream control means 26 in order to adjust the electrical power consumption of the processing means 12 as a function of the stream of digital data DATA.

In the selected embodiment, the transfer means DMA may be unidirectional or bidirectional. The invention applies in particular to controlling the transfer of encrypted digital data DATA from the storage area 18 to the input-output means 14.

1. Microcircuit card including:
input-output means (14) for digital data (DATA);
processing means (12) for processing this data; and
stream control means (26),
the microcircuit card being characterized in that the processing means (12) include:
transfer means (DMA) for transferring said digital data (DATA) between the input-output means (14) and a storage area (18); and
communication means (20) for communicating with the stream control means (26) security data (DATA_CTRL) obtained from said digital data (DATA),
the stream control means (26) being adapted to control the transfer of the digital data (DATA) by the transfer means (DMA) taking into account said security data (DATA_CTRL).

2. Microcircuit card according to claim 1, characterized in that said security data (DATA_CTRL) consists at least in part of a portion of said digital data (DATA).

3. Microcircuit card according to claim 2, characterized in that said security data (DATA_CTRL) includes authentication data (AUTH) for authenticating a portion (P1) of the digital data received by the card, the stream control means (26) being adapted to verify the validity of said digital data (DATA) on the basis of this authentication data (AUTH) and to control said transfer as a function of the result of this verification.

4. Microcircuit card according to claim 1, characterized in that said processing means (12) are adapted to insert into said security data (DATA_CTRL) a result of processing said digital data (DATA).

5. Microcircuit card according to claim 4, characterized in that said processing result is the result of a step of authenticating said digital data.

6. Microcircuit card according to claim 1, characterized in that the stream control means are adapted to modify at least one operating parameter of said transfer means (DMA).

7. Microcircuit card according to claim 6, characterized in that said parameter is selected from an address of said storage area (18) and a parameter for selecting a protocol for communication between the input-output means (14) and the storage area (18).

8. Microcircuit card according to claim 1, characterized in that said processing means (12) include a data compression unit (13), a data decompression unit, a data encryption unit or a data decryption unit.

9. Microcircuit card according to claim 1, characterized in that said stream control means (26) are adapted to stop the transfer of the digital data (DATA) by said transfer means (DMA) if they detect the presence of invalid authentication data in said digital data (DATA) on the basis of said security data (DATA_CTRL).

10. Microcircuit card according to claim 1, characterized in that the stream control means (26) are further adapted to obtain preliminary data directly from the input-output means (14), the stream control means (26) also taking account of the preliminary data in authorizing or refusing the transfer of the digital data (DATA) by the transfer means (DMA).

11. Microcircuit card according to claim 10, characterized in that said preliminary data includes authentication data (PASSWD).

12. Microcircuit card according to claim 10, characterized in that said data includes a storage address for said digital data.

13. Microcircuit card according to claim 1, characterized in that it further includes regulation means (PLL) adapted to modify a clock frequency applied to the processing means (12) as a function of said security data (DATA_CTRL).

14. Microcircuit card according to claim 1, characterized in that said transfer means (DMA) include a DMA component.

15. Microcircuit card according to claim 11, characterized in that said data includes a storage address for said digital data.
